(19) United States
(12) Patent Application Publication
(10) Pub. No.: US 2019/0226546 A1
(43) Pub. Date: Jul. 25, 2019

(54) Frequency-Dependent Damping Valve Arrangement

(71) Applicant: ZF FRIEDRICHSHAFEN AG, Friedrichshafen (DE)

(72) Inventor: Andreas FÖRSTER, Schweinfurt (DE)

(21) Appl. No.: 16/331,443

(22) PCT Filed: Aug. 3, 2017
(86) PCT No.: PCT/EP2017/069588

§ 371 Date: Mar. 7, 2019

(30) Foreign Application Priority Data
Sep. 8, 2016 (DE) 10 2016 217 114.3

(51) Int. Cl. F16F 9/348; F16F 9/512

(52) U.S. Cl. CPC F16F 9/3485; F16F 9/512; F16F 9/3488

(57) ABSTRACT

A frequency-dependent damping valve arrangement of a vibration damper for a motor vehicle includes a damping piston with a check valve. The damping piston is arranged inside a cylinder at least partially filled with a damping fluid and is axially fixed to a carrier. A control arrangement is arranged at the carrier coaxial to the damping piston and includes a control pot, an axially displaceable control piston arranged in the control pot, and at least one spring arrangement arranged between the control piston and the check valve and has at least a first spring element. The control piston has a height difference between its radially outer edge and its radially inner edge facing the radial center of the control piston, which height difference defines a maximum deflection height of the first spring element.

### CROSS-REFERENCE TO RELATED APPLICATIONS

This is a U.S. national stage of application No. PCT/EP2017/069588, filed on Aug. 3, 2017. Priority is claimed on German Application No. DE102016217114.3, filed Sep. 8, 2016, the content of which is incorporated herein by reference.

### BACKGROUND OF THE INVENTION

### 1. Field of the Invention

The invention is directed to a directed to a damping valve arrangement of a vibration damper for a motor vehicle with a frequency-dependent damping force characteristic.

### 2. Description of the Prior Art

A vibration damper in a motor vehicle is to damp the vibrations excited by the uneven road surface. In doing so, it is always necessary to find a compromise between driving safety and driving comfort. A vibration damper having a damping valve arrangement which is adjusted to be hard has a high damping force characteristic that is optimal for highly safe driving. If there is a high demand for comfort to be met, the damping valve arrangement should be adjusted to be as soft as possible. It is very difficult to find this compromise in a vibration damper with a conventional damping valve arrangement which is not electronically adjustable by means of an actuator.

A generic damping valve arrangement with a frequency-dependent damping force characteristic is known from DE 10 2014 210 704. This damping valve arrangement comprises a damping valve arranged inside a cylinder filled with a damping medium and which has at least one flow channel covered by a plurality of valve disks. The damping valve arrangement further comprises a control arrangement arranged coaxial to the damping valve and which comprises a control pot with an axially displaceable control piston arranged in the control pot. The control piston axially limits a control space which is enclosed in the control pot and which is connected to the damping valve arrangement via an inlet connection. A spring element is arranged between the control piston and the damping valve and axially introduces a spring force into the control piston on the one hand and into the damping valve on the other hand. When the control space is filled with damping medium, the control piston displaces in direction of the damping valve and, via the spring element, increases the pressing pressure of the valve disks of the damping valve, which increases the damping force.

The increase in pressing force of the valve disk of the check valve and, accordingly, also the increase in damping force depend, inter alia, on the pressure of the damping medium inside the control space and on the spring rate of the spring element.

### SUMMARY OF THE INVENTION

It is an object of one aspect of the present invention to provide an alternative frequency-selective damping valve arrangement that offers a possibility for increasing the pressing pressure of the valve disk of the check valve and, therefore, also for adjusting the increase in damping force in a defined manner.

According to one aspect of the invention, the control piston has a height difference between its radially outer edge and its radially inner edge facing the radial center of the control piston, which height difference defines a maximum deflection height and the deflection shape of the first spring element.

By determining a difference in height between the radially outer edge of the control piston and the radially inner edge of the control piston, the spring rate of the spring arrangement can be influenced and, accordingly, the increase in pressing pressure of the valve disk of the check valve and, therefore, also the increase in damping force can be adjusted in a defined manner.

According to an advantageous constructional variant, the height difference can be determined in that the radially outer edge of the control piston can be constructed so as to be raised relative to the rest of the surface of the control piston facing the first spring element. However, it can also be provided that the radially inner edge of the control piston is constructed so as to be raised relative to the rest of the surface of the control piston facing the first spring element. Both constructional variants can be produced simply and economically.

The damping valve arrangement can advantageously comprise at least one additional spacer component part arranged between the control piston and the first spring element, which facilitates a fine adjustment of the height difference.

According to a further advantageous construction, the shape-related configuration of the surface of the control piston facing the first spring element between the radially outer edge and the radially inner edge of the control piston can be adapted to the shape-related configuration of the first spring element in the loaded condition thereof, which favors a very accurate fine adjustment of the deflection height and the deflection shape of the first spring element.

In particular, it can be provided in an advantageous manner that the raised radially outer edge has an inner corner whose shape-related configuration is adapted to the shape-related configuration of the first spring element adopted by the spring element after deformation thereof up to the maximum permissible deflection height defined by the height difference of the control piston.

Further, the piston can have been advantageously produced from a plastic and/or the radially outer edge of the control piston can have been divided into a plurality of segments which can have, for example, different axial height or different surface configuration in order to reduce the weight of the control piston and/or to define the contact geometry of the first spring element at the piston. By “contact geometry” is meant in this connection the surface geometry of the control piston with which the first spring element comes in contact in its loaded state.

### BRIEF DESCRIPTION OF THE DRAWINGS

The invention will now be described in more detail referring to the figures. The drawings show:

FIG. 1 is a sectional view of an exemplary constructional variant of a frequency-dependent damping valve arrangement in a cylinder of a vibration damper;

FIG. 2 is a sectional view of an exemplary constructional variant of a control piston;

FIG. 3 is a detail of a control piston according to FIG. 2, in sectional view;

FIG. 4 is a detail of the control piston according to FIG. 3 with the first spring element of the spring arrangement in the loaded state, in sectional view; and

FIG. 5 is a top view of the control piston according to FIGS. 1 to 4.

### DETAILED DESCRIPTION OF THE PRESENTLY PREFERRED EMBODIMENTS

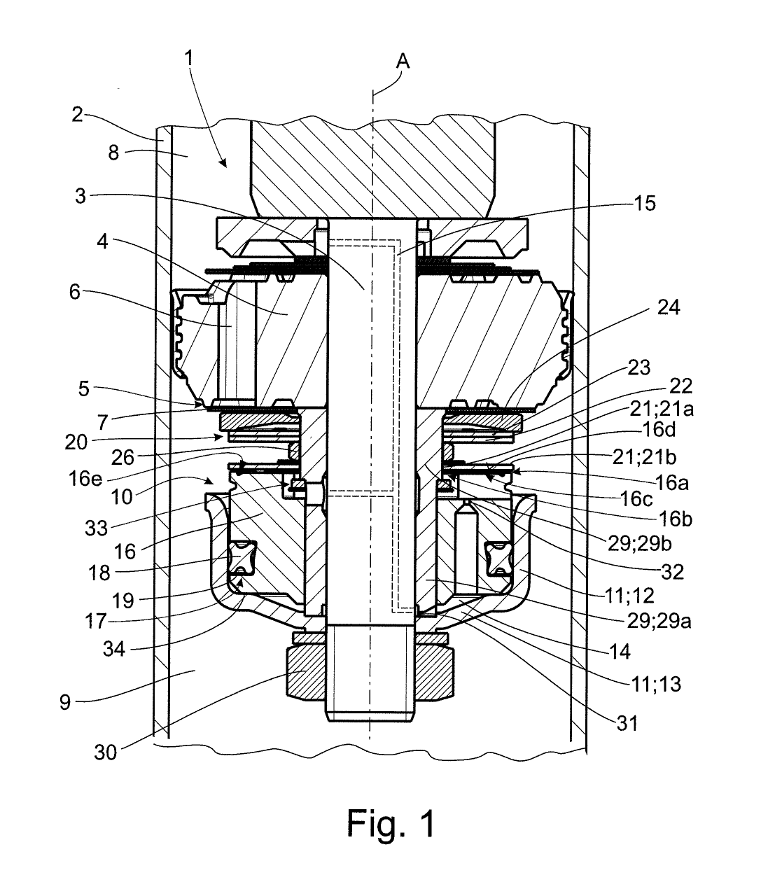

FIG. 1 shows a portion of a vibration damper for a motor vehicle with a frequency-dependent damping valve arrangement 1 according to one aspect of the invention in a sectional view.

The damping vale arrangement 1 comprises a cylinder 2 which is at least partially filled with a damping fluid.

The damping valve arrangement 1 is axially displaceably arranged inside the cylinder 2 and is fastened to a carrier 3. Damping valve arrangement 1 comprises a damping piston 4 with at least one check valve 5, this check valve 5 having at least a first flow channel 6 formed therein for the damping fluid, which flow channel 6 is covered by at least one valve disk 7.

Damping piston 4 divides a first working chamber 8 from a second working chamber 9 inside the cylinder 2 such that the ratio of the damping medium pressure in the two working chambers 8, 9 varies depending on the direction of axial movements of damping piston 4 in cylinder 2.

Further, damping valve arrangement 1 has a control arrangement 10 that contains a control pot 11 with a cylindrical pot wall 12 and a disk-shaped pot base 13 with a control piston 16, which is axially displaceably, arranged in control pot 11 and which axially limits a control space 14 enclosed in control pot 11.

A spring arrangement 20 acts axially upon valve disk 7 in direction of first flow channel 6 and upon control piston 16 in direction of pot base 13 with a defined spring force is arranged between damping piston 4 and control arrangement 1.

All of the structural component parts of damping valve arrangement 1 are arranged coaxial to one another at carrier 3. As is shown in FIG. 1, damping valve arrangement 1 is constructed in such a way that carrier 3 extends centrally through damping piston 4 and a guide sleeve 29 which in turn likewise extends centrally through spring arrangement 20 and control piston 16. Guide sleeve 29 comprises a first guide portion 29a and a second guide portion 29b axially adjacent thereto. Control piston 16 can slide axially along first guide portion 29a, and spring arrangement 20 can slide axially along second guide portion 29b. The direction of the axial movements of control piston 16 depends on the damping medium pressure in control space 14.

Carrier 3 is shown here as a so-called piston rod tenon, i.e., an end portion of the piston rod having a reduced diameter. In the constructional variant shown in FIG. 1, it is provided that damping valve arrangement 1 comprises at least one second flow channel 15 formed at and/or in carrier 3 and guide sleeve 29 and which joins first working space 8 and/or second working space 9 with control space 14.

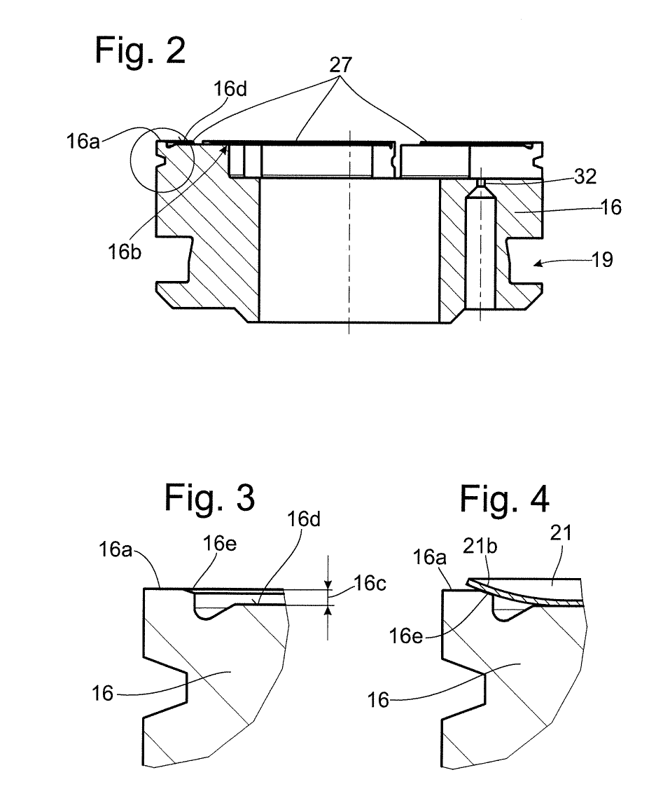

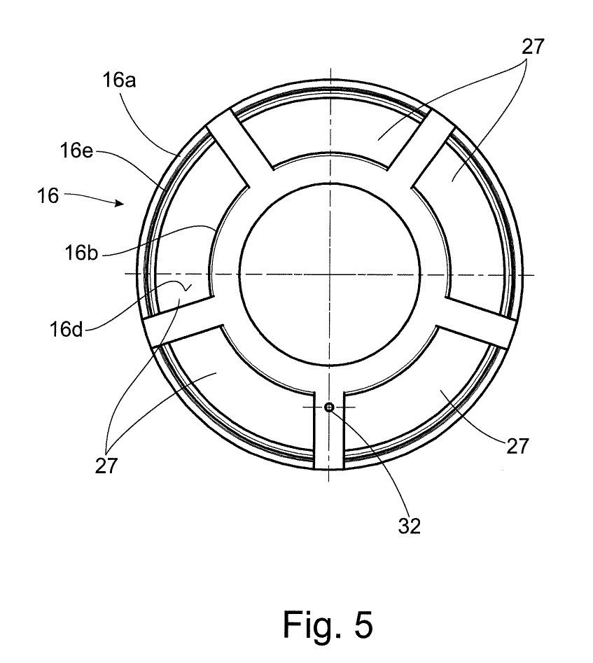

Control pot 11 of control arrangement 1 is connected to carrier 3 in the area of pot base 13 with the aid of connection 30. Connection 30 is shown in FIGS. 1 and 2 as a threaded nut. It will be appreciated that connection 30 can also have a different suitable constructional form. In general, carrier 3 can be connected to control pot 11 by bonding engagement and/or positive engagement and/or frictional engagement.

Control piston 16 arranged inside control pot 11 is constructed so as to be axially displaceable so that when a damping fluid pressure persists over a longer period of time in control space 14 of control arrangement 1 the control piston 16 is displaced in direction of valve disk 7 of check valve 5 and can tighten spring arrangement 20 so that the spring force acting on valve disk 7 through spring arrangement 20 and, therefore, the damping force of check valve 5 are increased.

As is shown in FIG. 1, control piston 16 has a seal arrangement 17, which seals control piston 16 relative to pot wall 12. This seal arrangement 17 comprises a circumferential groove 21 formed at control piston 16 and which has a seal ring 18 arranged therein.

Second flow channel 15 comprises an inlet restrictor 31 which defines the flow of damping medium out of first working chamber 8 into control space 14.

Further, an outlet restrictor 32 is formed at control piston 16 and influences the flow of damping medium out of control chamber 14. This outlet restrictor 40 can also be formed at carrier 3.

A first stop 33 and second stop 34 are formed at control arrangement 1 for defining the soft damping characteristic and hard damping characteristic. First stop 33 is formed as a stop ring in the constructional variant shown in FIG. 1, and second stop 34 is formed as an at least partial ridge of pot base 13. It will be appreciated that second stop 34 can also be formed as a stop ring or as an additional stop element be arranged inside of control space 14.

Spring arrangement 20 can be constructed in a variety of ways. In the constructional variant shown in FIG. 1, it is provided that spring arrangement 20 comprises a plurality of spring elements 21, 22, 23 separated from one another by a sliding element 26. Spring elements 21, 22, 23 and sliding element 26 surround guide sleeve 29 and are arranged coaxial to the rest of the structural component parts of damping valve arrangement 1. First spring element 21 is axially supported at control piston 16 on one side and at sliding element 26 on the other side. At least one of the further spring elements is axially supported at least indirectly at sliding element 26 on the one side and at valve disk 7 via a spacer ring 24 on the other side.

During a high-frequency excitation of the vibration damper, the damping fluid pressure persists only briefly in control space 14, whereas the damping fluid pressure persists significantly longer in control space 14 during a low-frequency excitation of the vibration damper.

Control arrangement 10 of damping valve arrangement 1 is constructed such that when a damping fluid pressure persists for a longer period of time in control space 14 of control arrangement 10 control piston 16 displaces in direction of valve disk 7 of check valve 5, tensions springs arrangement 20 and accordingly increases the spring force impinging on valve disk 7 through spring arrangement 20 and, therefore, increases the damping force of check valve 5.

As has already been explained, damping valve arrangement 1 according to one aspect of the invention comprises a spring arrangement 20 arranged between control piston 16 and check valve 5, which impinges with a defined spring force on valve disk 7 axially in direction of damping piston 4 and on control piston 16 in direction of pot base 13. This spring arrangement 20 has at least a first spring element 21 with an inner edge 21a facing carrier 3 and an outer edge 21b remote of carrier 3. Spring element 21 is supported axially directly at control piston 16 by at least one of the two edges 21a, 21b and at least indirectly at check valve 5 by the other of the two edges 21a, 21b. When the damping medium pressure in control space 14 increases, control piston 16 displaces axially in direction of check valve 5 and tightens spring arrangement 20. In this load state, at least the first spring element 21 deflects and introduces a spring force into control piston 16 and at least indirectly into check valve 5.

As is shown in all of the Figures, control piston 16 is constructed such that it has a height difference 16c between its radially outer edge 16a and its radially inner edge 16b facing the radial center of control piston 16. This height difference 16c defines a maximum deflection height of first spring element 21 and makes it possible to increase the pressing pressure of valve disk 7 at check valve 5 and, therefore, also to adjust the increase in damping force in a defined manner.

The height difference 16c can be determined, for example, in that radially outer edge 16a of control piston 16 is constructed so as to be raised relative to the rest of the surface 16d of control piston 16 facing first spring element 21 as is shown in FIGS. 2, 3 and 4. Alternatively, however, it can also be provided that the radially inner edge 16b of the control piston is constructed so as to be raised relative to the rest of the surface 16d of control piston 16 facing first spring element 21. This constructional variant is not shown in the drawings, but likewise falls within the protective scope of the present invention.

According to the constructional variant shown in FIG. 2, radially outer edge 16a of control piston 16 can be divided into a plurality of segments 27.

Further, the shape-related configuration of surface 16d of control piston 16 facing first spring element 21 between radially outer edge 16a and radially inner edge 16b of control piston 16 can be adapted to the shape-related configuration of first spring element 21.

An example of the latter is particularly clear from FIGS. 3 and 4 viewed in conjunction. As is shown in FIGS. 3 and 4, the raised radially outer edge 16a can have an inner corner 16e whose shape-related configuration is adapted to the shape-related configuration of first spring element 21 adopted by spring element 16 after deformation thereof up to the maximum permissible deflection height defined by height difference 16c of control piston 16.

As has already been described, it can be provided that damping valve arrangement 1 comprises at least one additional spacer component part 28 arranged between control piston 16 and first spring element 21 and which serves for fine adjustment of height difference 16c. This constructional variant is not shown in the drawings but can also be realized within the scope of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A frequency-dependent damping valve arrangement of a vibration damper, comprising:
a carrier;
a damping piston with a check valve and configured to be arranged inside at least one cylinder, which is at least partially filled with a damping fluid, and axially fixed to the carrier;
a control arrangement arranged at the carrier, coaxial to the damping piston, that comprises:
a control pot;
an control piston that is axially displaceable and arranged in the control pot; and
at least one spring arrangement arranged between the control piston and the check valve and has at least a first spring element that is supported axially directly at the control piston on one side and is supported at least indirectly at the check valve on an other side, deflects in loaded condition and introduces a spring force into the control piston and at least indirectly into the check valve;
wherein the control piston has a height difference between its one radially outer edge and its one radially inner edge facing a radial center of the control piston, the height difference defining a maximum deflection height of the first spring element.

10. The frequency-dependent damping valve arrangement according to claim 9,
wherein the first spring element of the spring arrangement comprises an inner edge facing the carrier and an outer edge remote of the carrier, and
wherein the first spring element is supported axially directly at the control piston by at least one of the inner edge and the outer edge and is supported at least indirectly at the check valve by the other one of inner edge and the outer edge, deflects in loaded condition and introduces a spring force into the control piston and at least indirectly into the check valve.

11. The frequency-dependent damping valve arrangement according to claim 9, wherein the height difference is determined such that the radially outer edge of the control piston is constructed to be raised relative to a rest of the surface of the control piston facing the first spring element.

12. The frequency-dependent damping valve arrangement according to claim 9, wherein the radially outer edge of the control piston is divided into a plurality of segments.

13. The frequency-dependent damping valve arrangement according to claim 9, wherein the raised radially outer edge has an inner corner whose shape-related configuration is adapted to a shape-related configuration of the first spring element adopted by spring element after deformation thereof up to the maximum permissible deflection height defined by the height difference of the control piston.

14. The frequency-dependent damping valve arrangement according to claim 11, wherein a shape-related configuration of the surface of the control piston facing the first spring element between the radially outer edge and radially inner edge of the control piston is adapted to a shape-related configuration of the first spring element.

15. The frequency-dependent damping valve arrangement according to claim 9, wherein the damping valve arrangement comprises at least one additional spacer component part arranged between the control piston and the first spring element.

16. A vibration damper comprising:
at least one cylinder, which is at least partially filled with a damping fluid;
a frequency-dependent damping valve arrangement, comprising:
a carrier;
a damping piston with a check valve and configured to be arranged inside the at least one cylinder and axially fixed to the carrier;
a control arrangement arranged at the carrier, coaxial to the damping piston, that comprises:
a control pot;
an control piston that is axially displaceable and arranged in the control pot; and
at least one spring arrangement arranged between the control piston and the check valve and has at least a first spring element that is supported axially directly at the control piston on one side and is supported at least indirectly at the check valve on an other side, deflects in loaded condition and introduces a spring force into the control piston and at least indirectly into the check valve;
wherein the control piston has a height difference between its one radially outer edge and its one radially inner edge facing a radial center of the control piston, the height difference defining a maximum deflection height of the first spring element.
